(19) United States
(12) Patent Application Publication
(10) Pub. No.: US 2016/0054860 A1
(43) Pub. Date: Feb. 25, 2016

(54) INPUT DEVICE

(71) Applicant: SHARP KABUSHIKI KAISHA, Osaka (JP)

(72) Inventors: Hideharu TAJIMA, Osaka-shi (JP); Takanobu SATO, Osaka-shi (JP)

(21) Appl. No.: 14/779,033

(22) PCT Filed: Dec. 26, 2013
(86) PCT No.: PCT/JP2013/084894

§ 371 Date: Sep. 22, 2015

(30) Foreign Application Priority Data
Mar. 27, 2013 (JP) 2013-067607

(51) Int. Cl. G06F 3/042; G06F 3/0488

(52) U.S. Cl. CPC G06F 3/0426; G06F 3/0488

(57) ABSTRACT

A television (1) includes a projection position specifying unit (151, 156) that determines a position at which an image used for input, with which a user performs an input operation, is to be projected onto a projection surface of an object to be projected onto, based on an operation by the user, which indicates the position, or a physical change generated in conjunction with the operation, and an image analysis unit (154) that specifies a position instructed by the user with respect to the image used for input, which is projected onto the projection surface.

### TECHNICAL FIELD

The present invention relates to an input device that receives, from a user, an input for equipment to be operated.

### BACKGROUND ART

In recent years, a technique that, when equipment is controlled from a remote position, projects an image used for input for receiving an input operation of a user and controls the equipment with a user operation on the image used for input has been proposed in place of an input device, such as a remote controller, which is conventionally used.

For example, PTL 1 described below discloses a technique for detecting a position and a moving direction of an operating object, such as a hand of a user, in a projected image, and for displaying a user interface image (image used for input) according to a detection result.

### CITATION LIST

### Patent Literature

PTL 1: Japanese Unexamined Patent Application Publication No. 2009-64109 (publication date: Mar. 26, 2009)

### SUMMARY OF INVENTION

### Technical Problem

However, PTL 1 above describes determining orientation of an image used for input at a predetermined position, but does not describe a technique for changing a position at which the image used for input is projected.

The invention has been made in view of the aforementioned problem, and an object thereof is to provide an input device capable of projecting the aforementioned image used for input at a position desired by a user.

### Solution to Problem

In order to solve the aforementioned problem, an input device according to one aspect of the invention is an input device that receives, from a user, an input for target equipment, including projection position determination means for determining a position at which an image used for input, with which the user performs an input operation, is to be projected onto a projection surface of an object to be projected onto, based on an operation by the user, which indicates the position, or a physical change generated in conjunction with the operation, and instructed position specifying means for specifying a position instructed by the user to the image used for input, which is projected onto the projection surface.

### Advantageous Effects of Invention

According to one aspect of the invention, an effect is realized in that the aforementioned image used for input is able to be projected at a position desired by a user.

### BRIEF DESCRIPTION OF DRAWINGS

FIG. 1 is a block diagram illustrating one example of a configuration of a main part of a television according to Embodiment 1 of the invention.

FIG. 2 is a schematic view illustrating a configuration of a television control system according to Embodiment 1 of the invention.

FIG. 3 is a schematic view illustrating one example of an image used for input projected by the television according to Embodiment 1 of the invention.

FIG. 4 is a flowchart illustrating one example of a flow of processing in the television according to Embodiment 1 of the invention.

FIG. 5 is a block diagram illustrating one example of a configuration of a main part of a television according to Embodiment 2 of the invention.

FIG. 6 is a schematic view illustrating a configuration of a television control system according to Embodiment 2 of the invention.

FIG. 7 is a flowchart illustrating one example of a flow of processing in the television according to Embodiment 2 of the invention.

FIG. 8 is a block diagram illustrating one example of a configuration of a main part of a television according to Embodiment 3 of the invention.

FIG. 9 is a block diagram illustrating one example of a configuration of a main part of a television according to Embodiment 4 of the invention.

FIG. 10 is a schematic view illustrating a configuration of a television control system according to Embodiment 4 of the invention.

FIG. 11 is a block diagram illustrating one example of a configuration of a main part of an input control device according to Embodiment 5 of the invention.

FIG. 12 is a schematic view illustrating one example of an image used for input projected by the input control device according to Embodiment 5 of the invention.

### DESCRIPTION OF EMBODIMENTS

### Embodiment 1

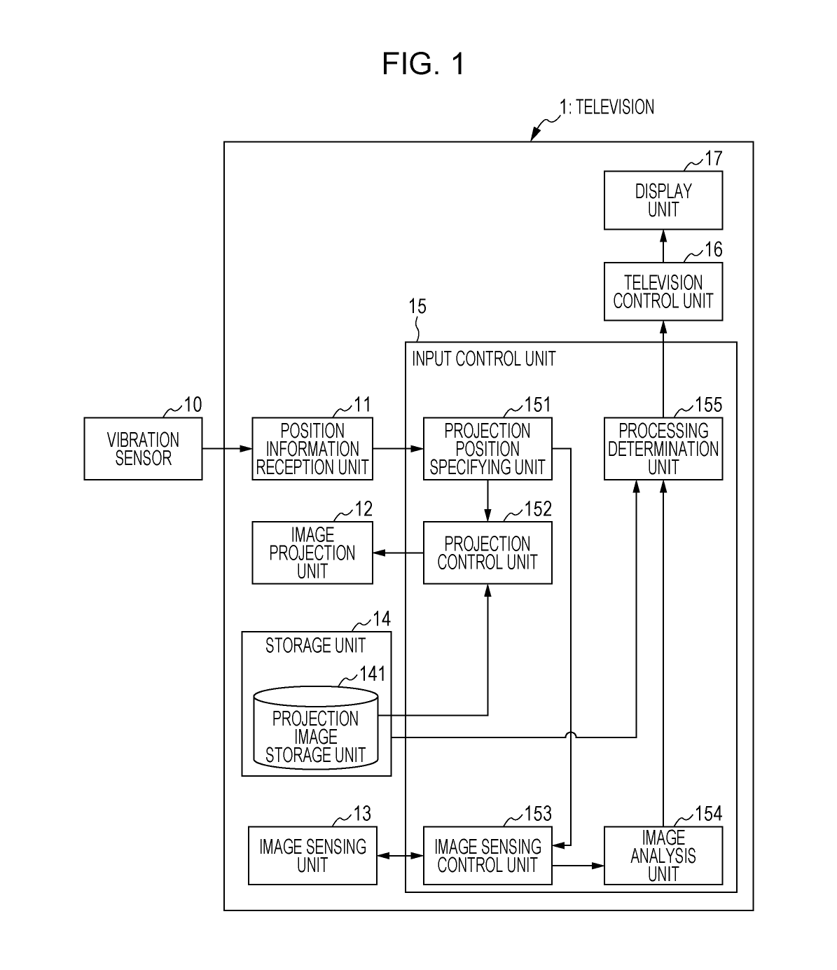

A television (television receiver, display device) 1 which is one aspect of an input device of the invention will be described in detail below based on FIGS. 1 to 4. Note that, the television 1 of the one aspect of the invention will be described as a television capable of having an Internet connection. However, the television according to the invention is not limited to the television capable of having an Internet connection and is only required to be able to receive broadcast waves and output a video image and audio.

Further, the invention is applicable to any equipment that functions according to an input operation by a user, such as an air conditioner and an illumination device, in addition to the aforementioned television. In addition, dimensional relationships among the lengths, sizes, widths, and the like and the shapes in the drawings have been changed appropriately for clarity and simplicity of the drawings and do not represent actual dimensions and shapes.

### [Outline of Television 1]

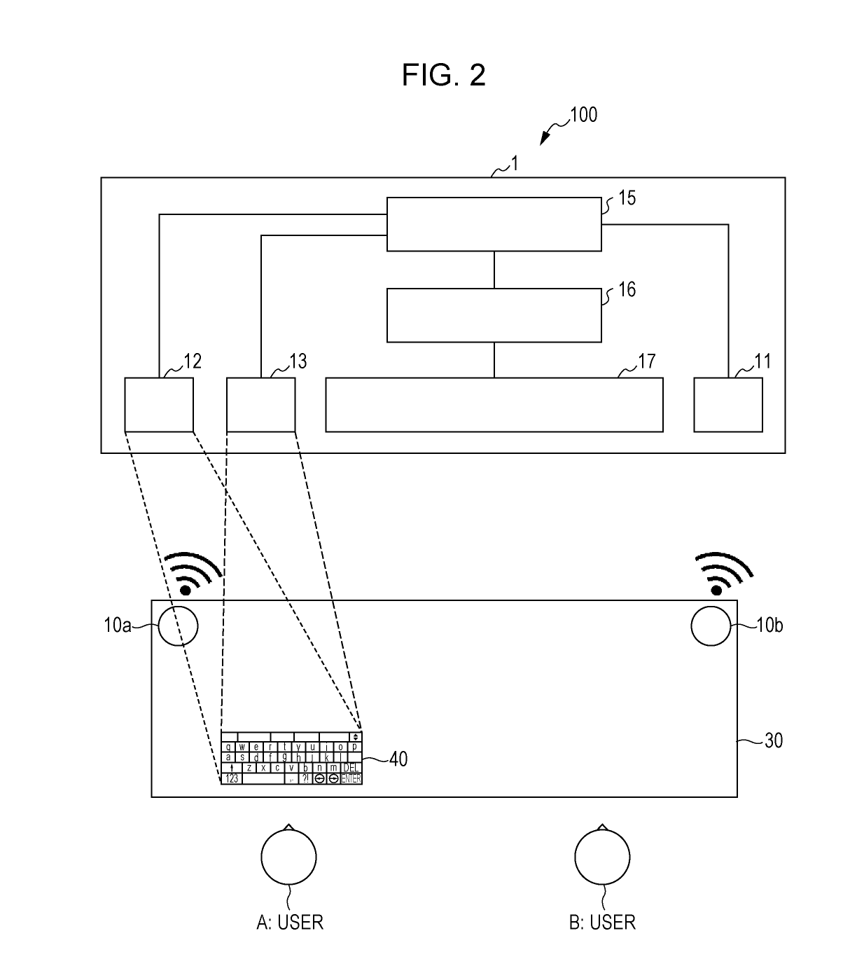

FIG. 2 is a schematic view illustrating a configuration of a control system 100 of the television 1 of the present embodiment. As illustrated in FIG. 2, the television 1 of the one aspect of the invention determines a position at which an image used for input 40, with which a user A performs an input operation, is to be projected onto a projection surface 30 of an object to be projected onto, based on a physical change (vibration) generated in conjunction with the operation of the user A, which indicates a projection position.

Specifically, the vibration which is generated by the operation performed on the projection surface 30 by the user A (such as tapping the projection surface 30) is detected by a plurality of vibration sensors 10a and 10b (refer to FIG. 1), and detection signals indicating that the vibration is detected are transmitted to the television 1. The television 1 analyzes the detection signals from the vibration sensors 10a and 10b to thereby determine a position at which the operation has been performed on the projection surface 30 by the user A. The television 1 then projects the image used for input 40 onto the position. The image used for input 40 is, for example, an image resembling a remote controller or a keyboard.

In the present embodiment, the object to be projected onto is a table such as a low table or a dining table, and a top of the table functions as the projection surface 30. As illustrated in FIG. 2, the plurality of vibration sensors 10a and 10b are arranged on the projection surface 30 at predetermined positions, which are different from each other. In FIG. 2, the vibration sensor 10a is arranged on a left end of the projection surface 30 and the vibration sensor 10b is arranged on a right end of the projection surface 30.

Therefore, for example, when the user performs an operation of tapping the projection surface 30, a required time until a vibration is transferred to each of the vibration sensors 10a and 10b changes according to a tapped position. When detecting the vibration, each of the vibration sensors 10a and 10b transmits a detection signal indicating the detection to the television 1.

A projection position specifying unit 151 of the television 1 (refer to FIG. 1) determines the position tapped by the user on the projection surface 30 based on a time difference between a timing at which the detection signal transmitted from the vibration sensor 10a is received and a timing at which the detection signal transmitted from the vibration sensor 10b is received and the order in which the detection signals are received.

An area of the projection surface 30, in other words, an area in a range where an image used for input is able to be projected is sufficiently large compared to an area of the image used for input 40. That is, by detecting an operation by the user of, for example, tapping the projection surface 30, which is performed at any position of the projection surface 30, such as a top of a low table or a dining table, which is sufficiently large compared to an area of an image used for input to be projected, the television 1 is able to regard the position at which the operation has been performed as a position at which the image used for input 40 is to be projected.

In addition, a processing determination unit 155 of the television 1 (refer to FIG. 1) specifies a position instructed by the user A to the image used for input 40 which has been projected. Specifically, the processing determination unit 155 performs imaging of an operation by the user A on the image used for input 40 (for example, an operation of touching the image used for input 40 with a finger), and analyzes a taken image to thereby specify the position instructed by the user A. The television 1 then executes processing according to the specified position.

Accordingly, the user A is able to project the image used for input 40 onto any position of the projection surface 30 which is sufficiently larger than the image used for input to be projected. Further, by performing an operation of designating a position on the image used for input 40 which has been projected, the user A is able to cause the television 1 to execute processing corresponding to the designated position. Thus, the user A is able to cause the television 1 to execute processing by using the image used for input 40 at a desired position, similarly to a case where a mobile input device such as a remote controller is used.

Moreover, by performing an operation of touching the image used for input 40 as if pressing a key or a button of a typical input device such as a keyboard or a remote controller, the user A is able to cause the television 1 to execute processing.

Here, when a user B who is at a position different from the user A performs an operation of, for example, tapping the projection surface 30, the television 1 similarly determines a position at which the operation is performed on the projection surface 30 by the user B and projects the image used for input 40 onto the position.

That is, when a plurality of users are at different positions, without moving from a current position, each of the users is able to project the image used for input 40 onto a desired position on the projection surface 30 and perform an input operation with respect to the image used for input 40 which has been projected.

### [Configuration of Television 1]

Next, a configuration of a main part of the television 1 as one aspect of the invention will be described in detail. FIG. 1 is a block diagram illustrating one example of the main part of the television 1 of the present embodiment.

As illustrated in FIG. 1, the television 1 includes at least a position information reception unit 11, an image projection unit 12, an image sensing unit 13, a storage unit 14, an input control unit 15, a television control unit 16, and a display unit 17.

### (Position Information Reception Unit 11)

The position information reception unit 11 is a communication device which is capable of wired communication or radio communication with the plurality of vibration sensors 10a and 10b which are externally provided and receives signals from the vibration sensors 10a and 10b. The vibration sensors 10a and 10b are arranged on the projection surface 30 as described above, detect a vibration in conjunction with an operation performed on the projection surface 30 by a user, and transmit detection signals indicating that the vibration is detected to the position information reception unit 11. When receiving the detection signals from the vibration sensors 10a and 10b, the position information reception unit 11 supplies the detection signals to the projection position specifying unit 151 described below.

Note that, a sensor which transmits a signal to the position information reception unit 11 is not limited to the vibration sensor 10. For example, an acceleration sensor may be used, and audio may be detected instead of a vibration. An example of a sensor for detecting audio includes a microphone. When the microphone is used as the sensor, however, erroneous operation due to audio of a television broadcast may be caused. Thus, also for enhancing the reliability of input to the television 1, a sensor which detects a vibration is more preferably used as the sensor which transmits a signal to the position information reception unit 11. Further, by using the sensor which detects a vibration, the user is able to display the image used for input 40 with a minimum operation of, for example, tapping the projection surface 30.

### (Input Control Unit 15)

Next, a configuration of the input control unit 15 will be described in detail. As illustrated in FIG. 1, the input control unit 15 is independent from the television control unit 16 described below. This makes it possible to realize an input device capable of being operated, even when the television 1 is in a standby state, similarly to a conventional input device such as a remote controller. Further, similarly to a case where an input device such as a remote controller is used, the user is able to switch on the television 1, which is in the standby state, from a position where the user watches it or to switch the television 1, which has been switched on, to a standby state.

The input control unit 15 includes the projection position specifying unit 151, a projection control unit 152, an image sensing control unit 153, an image analysis unit 154, and the processing determination unit 155, as illustrated in FIG. 1.

### (Projection Position Specifying Unit 151)

The projection position specifying unit (projection position determination means) 151 is a block which determines a position at which the image used for input 40, with which the user performs an input operation, is to be projected onto the projection surface 30 of an object to be projected onto, based on a physical change generated in conjunction with the operation by the user, which indicates a projection position.

Specifically, based on a time difference between a timing at which the detection signal (first detection signal) transmitted from the vibration sensor 10a is received and a timing at which the detection signal (second detection signal) transmitted from the vibration sensor 10b is received and the order in which the detection signals are received, the projection position specifying unit 151 determines, as the projection position of the image used for input 40, the position on the projection surface 30, which is tapped by the user. A formula for determining the projection position is stored in the storage unit 14 in advance. The projection position specifying unit 151 calculates the projection position by assigning, to the formula, for example, (i) the time difference and (ii) information indicating which of the first detection signal and the second detection signal was received first.

The projection position specifying unit 151 supplies projection position information indicating the specified projection position to the projection control unit 152 and the image sensing control unit 153.

### (Projection Control Unit 152)

The projection control unit 152 controls the image projection unit 12 to thereby project the image used for input 40 onto a position indicated by the projection position information supplied from the projection position specifying unit 151. Specifically, the projection control unit 152 reads the image used for input 40 from a projection image storage unit 141 and causes the image projection unit 12 to execute projection of the image used for input 40 at the projection position.

For example, an image resembling a keyboard is projected as the image used for input 40, as illustrated in FIG. 2. In the image resembling the keyboard, in addition to keys of a typical keyboard, a button resembling an on-button for switching the operation state and the standby state of the television 1 is displayed. The operation state is a state where an image and audio are output and the standby state is a state where power is supplied, but output of an image and audio is stopped. That is, when the television 1 is in the standby state, the television 1 is switched to the operation state when the user touches the on button.

After the television 1 is switched to the operation state, by touching the image used for input 40 resembling the keyboard while watching a display screen of the television 1, the user is also able to perform an input operation which is complex compared to an operation with a conventional remote controller. The image used for input 40 may allow an input operation corresponding to an operation of pressing a plurality of keys at the same time (for example, an operation of pressing an Enter key while pressing a Ctrl key), like a typical keyboard.

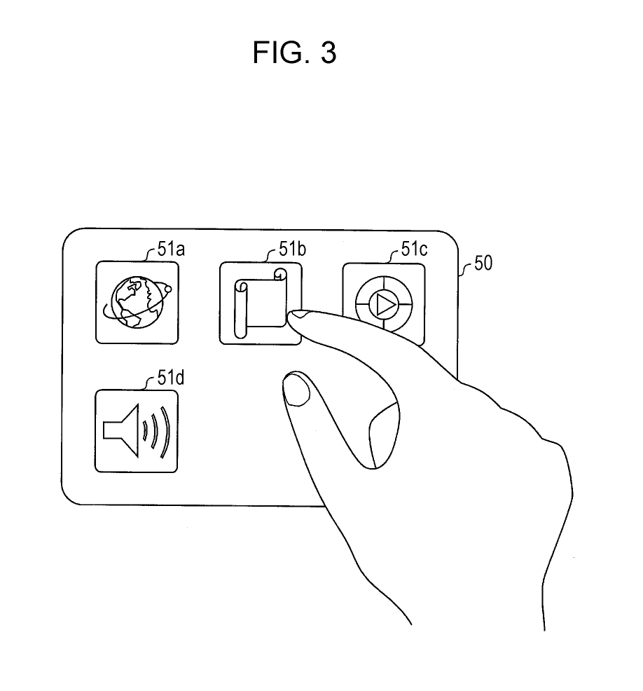

As the image used for input 40, an image which is selected in advance by the user may be projected, or an image to be projected may be determined by the projection control unit 152 according to a usage situation of the television 1. For example, when a television broadcast is viewed, the projection control unit 152 may project the image used for input 40 resembling a remote controller, and when an Internet browser is used, the projection control unit 152 may project the image used for input 40 resembling a keyboard. The image used for input may be an image used for input 50 resembling a display screen of a display of a so-called smartphone, as illustrated in FIG. 3. For example, icons 51 (51a to 51d) indicating each function of the television 1 are displayed in the image used for input 50, and when the user touches the icon 51, the television 1 may execute processing according to the touched icon 51.

In addition, the projection control unit 152 may be configured to display an arrow on the display unit 17 of the television 1 so that the user moves the arrow with his/her fingertip instead of moving the arrow by using a mouse. In this case, the image used for input 40 has a predetermined region resembling a touch pad, and the arrow may be moved according to movement of the fingertip in the region.

The image used for input 40 may have a region where a picture displayed on the display unit 17 of the television 1 is able to be enlarged and reduced so that the user performs pinch-in and pinch-out operations with his/her fingertip with respect to a display surface of the smart phone. For example, when the user performs pinch-in/pinch-out operations with respect to the image used for input 50, based on the operation, the television control unit 16 described below may change a size of a specific image displayed on the display unit 17.

The projection control unit 152 may display the image used for input 50 or the region resembling the touch pad at the same time with, for example, the image used for input 40 resembling the keyboard described above.

### (Image Sensing Control Unit 153)

The image sensing control unit 153 controls an image sensing direction (and an image sensing range) of the image sensing unit 13 for imaging so that an operation by the user on the image used for input 40, which is projected onto the position indicated by the projection position information supplied from the projection position specifying unit 151 is able to be imaged. The image sensing control unit 153 supplies data of an image obtained by imaging a region including the image used for input 40, which is taken by the image sensing unit 13, (image data) to the image analysis unit 154.

Note that, the region including the image used for input 40 refers to a region in which a position of the image used for input 40, which is instructed by the user, is able to be specified.

### (Image Analysis Unit 154)

The image analysis unit (instructed position specifying means) 154 is a block which specifies a position instructed by the user to the image used for input 40 projected onto the projection surface 30. Specifically, the image analysis unit 154 analyzes the image data, which is supplied from the image sensing control unit 153, and judges whether the user has performed an operation on the image used for input 40 (such as an operation of touching with his/her finger).

Further, when judging that the operation has been performed, the image analysis unit 154 specifies where in the image used for input 40 the user has touched and supplies touched position information indicating the specified position to the processing determination unit 155. Note that, the touched position may be specified by using a coordinate system which is set to an image of the image used for input 40, which is included in the image data.

### (Processing Determination Unit 155)

The processing determination unit 155 is a block which determines processing to be executed by the television 1 according to a position in the image used for input 40, which is instructed by the user (touched position). The storage unit 14 stores therein correlation information indicating a correlation between the touched position in the image used for input 40 which is projected and a type of a control signal to be transmitted to the television control unit 16. The processing determination unit 155 refers to the correlation information to specify a control signal corresponding to the touched position indicated by the touched position information supplied from the image analysis unit 154. The processing determination unit 155 supplies the specified control signal to the television control unit 16 described below.

Note that, when the input control unit 15 is realized as a device separated from the television 1, the processing to be executed by the television 1, which corresponds to the aforementioned control signal, may be determined not by the processing determination unit 155 but by the television 1.

### (Image Projection Unit 12)

The image projection unit 12 is a projector which projects the image used for input 40 at a projection position specified by the projection position specifying unit 151. The image projection unit 12 is able to change, according to the projection position, a projection direction thereof under control of the projection control unit 152. Thereby, the image projection unit 12 is able to project the image used for input 40 onto the projection position.

### (Image Sensing Unit 13)

The image sensing unit 13 is a camera for an imaging operation by the user. Specifically, the image sensing unit 13 performs imaging of a region including the image used for input 40 which is projected, and supplies image data to the image sensing control unit 153.

### (Storage Unit 14)

The storage unit 14 is a storage region in which a control program executed by the input control unit 15 and various data (such as a setting value and a table) read when the control program is executed are stored. As the storage unit 14, various conventionally well-known storage means, for example, such as a ROM (Read Only Memory), a RAM (Random Access Memory), a flash memory, an EPROM (Erasable Programmable ROM), an EEPROM (registered trademark) (Electrically EPROM), and an HDD (Hard Disk Drive), is usable. Further, various data and data being processed, which are handled in the input control unit 15, are temporarily stored in a working memory of the storage unit 14.

The storage unit 14 of the present embodiment includes the projection image storage unit 141. The projection image storage unit 141 is a storage region in which various data of the image used for input 40 are stored. Moreover, the storage unit 14 stores therein information indicating a correlation between the position specified to the image used for input 40 which is projected and processing to be executed in the television 1 (not illustrated).

### (Television Control Unit 16)

The television control unit 16 is a control device which controls various functions of the television 1. The television control unit 16 executes processing indicated by the control signal supplied from the processing determination unit 155. For example, when the control signal is information indicating change of a channel, the television control unit 16 receives broadcast waves corresponding to the channel after the change, and causes the display unit 17 described below to display an image. In addition, when the control signal is information indicating acquisition of a content by Internet connection, the television control unit 16 acquires a content from an external server (not illustrated), and causes the display unit 17 to display an image of the content. Further, when the control signal is information indicating switching-on of the television 1 in the standby state or shifting to the standby state, the television control unit 16 starts or stops output of an image or audio.

The processing executed by the television control unit 16 is not limited to the above. That is, the television control unit 16 executes processing for realizing a function which is set in advance to the television 1. For example, change of a volume, display of a program list, start of an Internet browser, or the like is one example of the processing.

Lastly, the display unit 17 is a display device which displays information to be processed by the television 1 as an image. Information processed by the television control unit 16 is displayed on the display unit 17. The display unit 17 is composed of a display device, for example, such as an LCD (liquid crystal display).

### [Flow of Processing for Determining Input Operation]

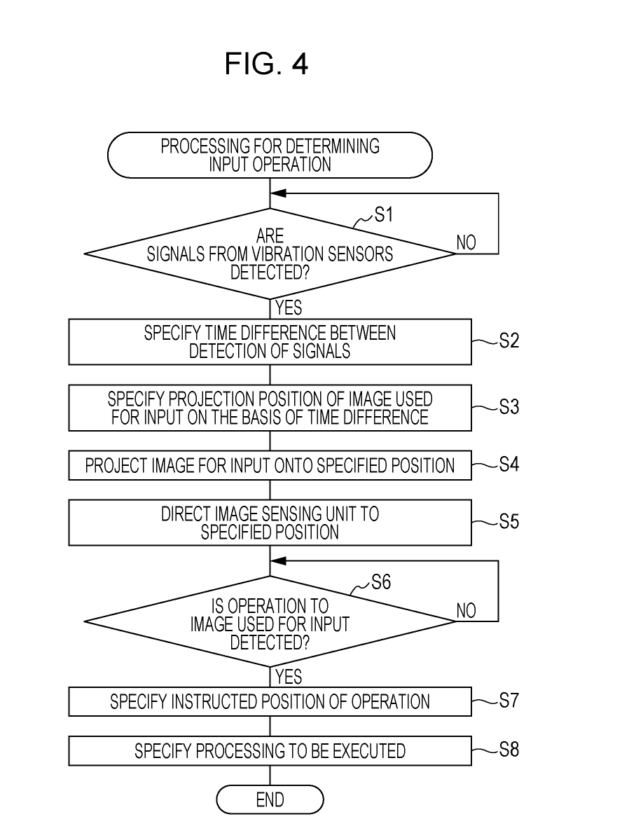

Subsequently, a flow of processing for determining an input operation in the television 1 according to the present embodiment will be described. FIG. 4 is a flowchart illustrating one example of the flow of input processing in the television 1.

First, when receiving first and second detection signals, which indicate that a vibration in conjunction with an operation of a user is detected, from the plurality of vibration sensors 10a and 10b (YES at S1), the position information reception unit 11 supplies the first and second detection signals which have been received to the projection position specifying unit 151.

The projection position specifying unit 151 then calculates a time difference between a timing at which the first detection signal is received and a timing at which the second detection signal is received (S2). Further, the projection position specifying unit 151 specifies a position at which the vibration on the projection surface 30 is generated, that is, a position at which the operation by the user is performed based on the calculated time difference and the order in which the detection signals are received (S3: projection position determination step).

Thereafter, the projection position specifying unit 151 supplies projection position information indicating the specified position to the projection control unit 152 and the image sensing control unit 153.

Next, the projection control unit 152 changes a projection direction of the image projection unit 12 according to the projection position information supplied from the projection position specifying unit 151 (S4), reads the image used for input 40 from the projection image storage unit 141, and causes the image projection unit 12 to execute projection of the image used for input 40 onto the aforementioned projection position.

The image sensing control unit 153 then changes an image sensing direction of the image sensing unit 13 so as to allow imaging of an operation by the user with respect to the image used for input 40 which is displayed at the projection position indicated by the projection position information supplied from the projection position specifying unit 151, and causes the image sensing unit 13 to execute the imaging (S5). The image sensing control unit 153 supplies image data indicating an image taken by the image sensing unit 13 to the image analysis unit 154. The imaging by the image sensing unit 13 may be performed at a predetermined time interval after the image used for input 40 is projected.

Next, when detecting an operation by the user, which indicates a position in the image used for input 40, as a result of analyzing the image data which is supplied (YES at S6), the image analysis unit 154 further analyzes the image data to thereby detect a coordinate of a position instructed by the user on the image used for input 40 (S7: instructed position specifying step). Thereafter, the image analysis unit 154 supplies touched position information indicating the coordinate to the processing determination unit 155.

Finally, by referring to correlation information stored in the storage unit 14, the processing determination unit 155 reads information of processing to be executed by the television 1, which is associated with the coordinate indicated by the touched position information that is supplied, to thereby determine processing in the television 1 (S8). Then, the processing for determining an input operation ends.

Thereafter, the processing determination unit 155 supplies a control signal corresponding to the determined processing to the television control unit 16 and the television control unit 16 executes processing corresponding to the supplied control signal. For example, when the received control signal is information indicating shifting processing to the standby state, the television control unit 16 stops output of a video image and audio, resulting that the television 1 shifts to the standby state.

### Embodiment 2

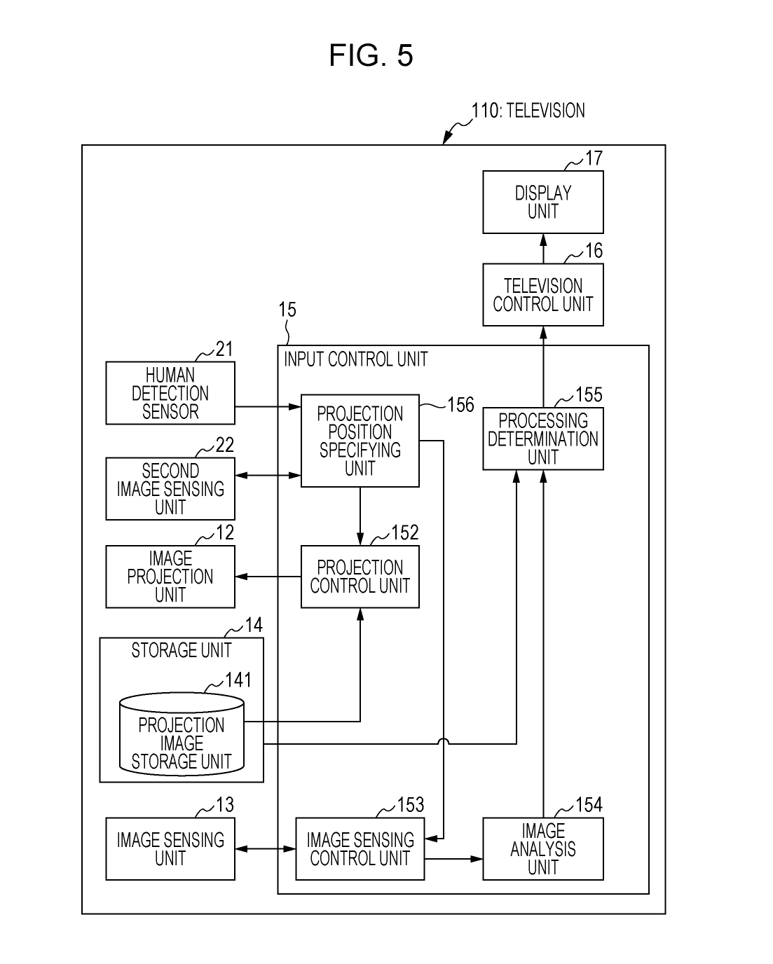

Another embodiment of the invention will be described based on FIG. 5 to FIG. 7 as follows. Note that, for convenience of description, the same reference signs are assigned to members having the same functions as those of the members described in the aforementioned embodiment and description thereof will be omitted.

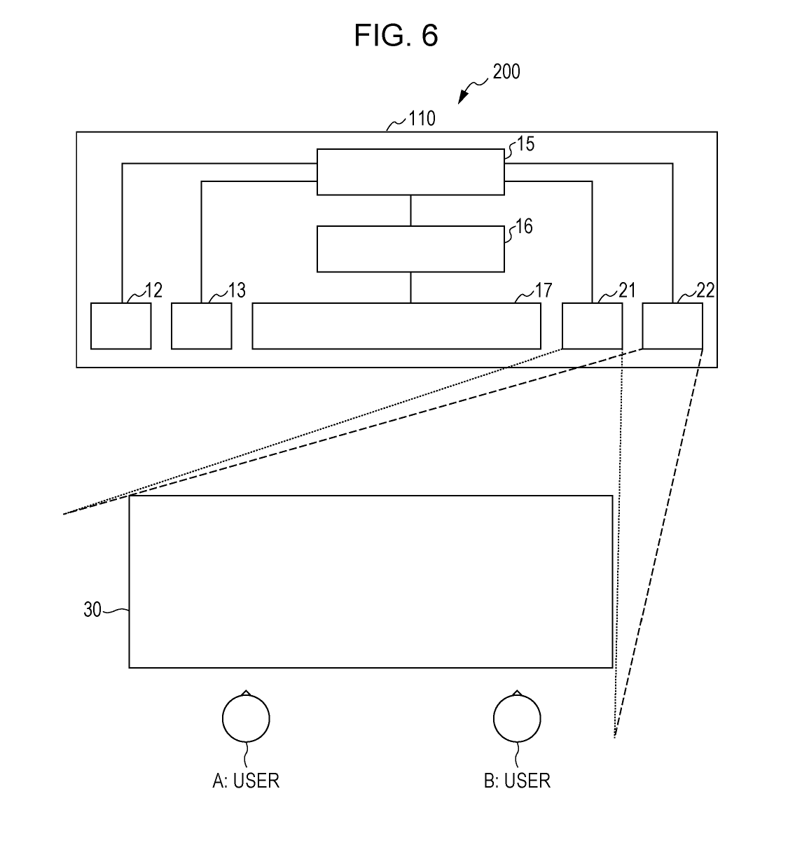

FIG. 6 is a schematic view illustrating a configuration of a control system 200 of a television 110 of the present embodiment. As illustrated in FIG. 6, the television 110 according to the present embodiment does not need the vibration sensor 10 outside thereof. That is, the television 110 further includes a human detection sensor 21 (refer to FIG. 5) which detects a position of a user A, and a second image sensing unit 22 (refer to FIG. 5) that performs imaging of an operation by the user A, and by operating the second image sensing unit 22 based on a detection result for the user A by the human detection sensor 21 and analyzing an image obtained by imaging the operation by the user, determines a position at which the image used for input 40, with which the user A performs an input operation, is to be projected onto the projection surface 30 of an object to be projected onto.

### [Configuration of Television 110]

FIG. 5 is a block diagram illustrating one example of a configuration of a main part of the television 110 of the present embodiment. The television 110 according to the present embodiment includes the human detection sensor 21 and the second image sensing unit 22 instead of the position information reception unit 11 which is included in the television 1 of Embodiment 1, as illustrated in FIG. 5. The television 110 further includes a projection position specifying unit 156 instead of the projection position specifying unit 151.

### (Human Detection Sensor 21)

The human detection sensor 21 (user position detection means) is a sensor which detects a position of the user within a detection range. The detection range of the human detection sensor 21 may be limited to the projection surface 30 and a spatial region in a vicinity thereof. In this case, the human detection sensor 21, when the user exists in the vicinity of the projection surface 30, detects a position of the user.

In the present embodiment, an example using an infrared sensor as the human detection sensor 21 will be described. Note that, the human detection sensor 21 is not limited to the infrared sensor, may be a temperature sensor, and may be any sensor as long as being able to detect a position of a user and being able to be provided in the television 1.

The human detection sensor 21 is a passive sensor, and receives infrared ray even when the television 1 is in the standby state, and when the user falls within the detection range, receives infrared ray irradiated from the user. Moreover, when detecting that the user is within the detection range by receiving the infrared ray irradiated from the user, the human detection sensor 21 supplies user position information indicating the position of the user to the projection position specifying unit 156. Note that, the human detection sensor 21 may be an infrared active sensor.

### (Second Image Sensing Unit 22)

The second image sensing unit 22 is a camera for imaging an operation by the user who instructs a position at which the image used for input 40 is projected. Specifically, the second image sensing unit 22 performs imaging of a region including the position of the user, which is detected by the human detection sensor 21, and supplies image data indicating a taken image to the projection position specifying unit 156. Here, the “region including the position of the user” is a region in a predetermined range with the position indicated by the user position information as a center. After the human detection sensor 21 detects the position of the user, the second image sensing unit 22 performs the aforementioned imaging at a predetermined time interval and supplies each of the image data to the projection position specifying unit 156.

### (Projection Position Specifying Unit 156)

When the human detection sensor 21 detects existence of the user, first, the projection position specifying unit (projection position determination means) 156 causes the second image sensing unit 22 to execute imaging. Note that, when a user position which is detected is out of an imaging range of the second image sensing unit 22 at that time, the projection position specifying unit 156 causes the second image sensing unit 22 to execute imaging after controlling an image sensing direction according to the user position information.

Moreover, the projection position specifying unit 156 determines a position at which the image used for input 40, with which the user performs an input operation, is to be projected onto the projection surface 30 of an object to be projected onto, based on operation by the user, which indicates the projection position. That is, by analyzing the image data acquired by the second image sensing unit 22, the projection position specifying unit 156 determines which position on the projection surface 30 the user has instructed as the projection position. The projection position specifying unit 156 supplies projection position information indicating the specified position to the projection control unit 152 and the image sensing control unit 153.

The operation of instructing the projection position is, for example, an operation of touching a surface of the projection surface 30 with a forefinger. In this case, the projection position specifying unit 156 may specify a position, which is touched by the user with his/her forefinger, as the projection position of the image used for input 40.

### [Flow of Processing for Determining Input Operation]

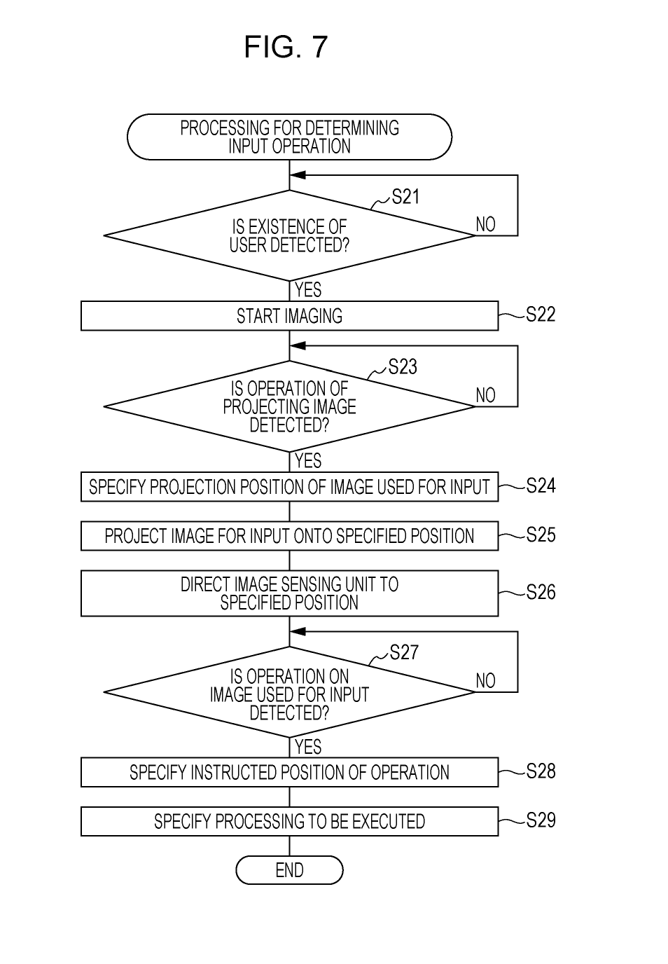

Subsequently, a flow processing for determining an input operation in the television 110 according to the present embodiment will be described. FIG. 7 is a flowchart illustrating one example of the flow of processing for determining an input operation in the television 110.

First, when the human detection sensor 21 detects existence of a user (YES at S21), user position information is transmitted to the projection position specifying unit 156. The projection position specifying unit 156 controls an image sensing direction of the second image sensing unit 22 based on the received user position information and then causes the second image sensing unit 22 to execute imaging (S22).

The projection position specifying unit 156 analyzes image data acquired by the second image sensing unit 22. When detecting an operation of instructing a projection position of the image used for input 40 as a result of analyzing the image data (YES at S23), the projection position specifying unit 156 specifies an instructed position by the user with respect to a projected image of the image used for input 40 included in an image (S24: projection position determination step). The projection position specifying unit 156 supplies projection position information indicating the specified position to the projection control unit 152 and the image sensing control unit 153.

Subsequent processing from step S25 to step S29 is similar to Embodiment 1. That is, since the processing from step S25 to step S29 is similar to processing from step S4 to step S8 illustrated in FIG. 4, description thereof will be omitted.

Accordingly, the television 110 according to the present embodiment uses the human detection sensor 21 and the second image sensing unit 22 to specify a position at which the image used for input 40 is projected. Thereby, it becomes unnecessary to provide the vibration sensor 10 on the projection surface. Thus, it is possible to further expand flexibility of the position at which the image used for input 40 is projected. For example, it also becomes possible to use, a floor of a living room or the like in which a large indefinite number of vibrations may be generated, as the projection surface 30 to project the image used for input 40 thereon.

### Embodiment 3

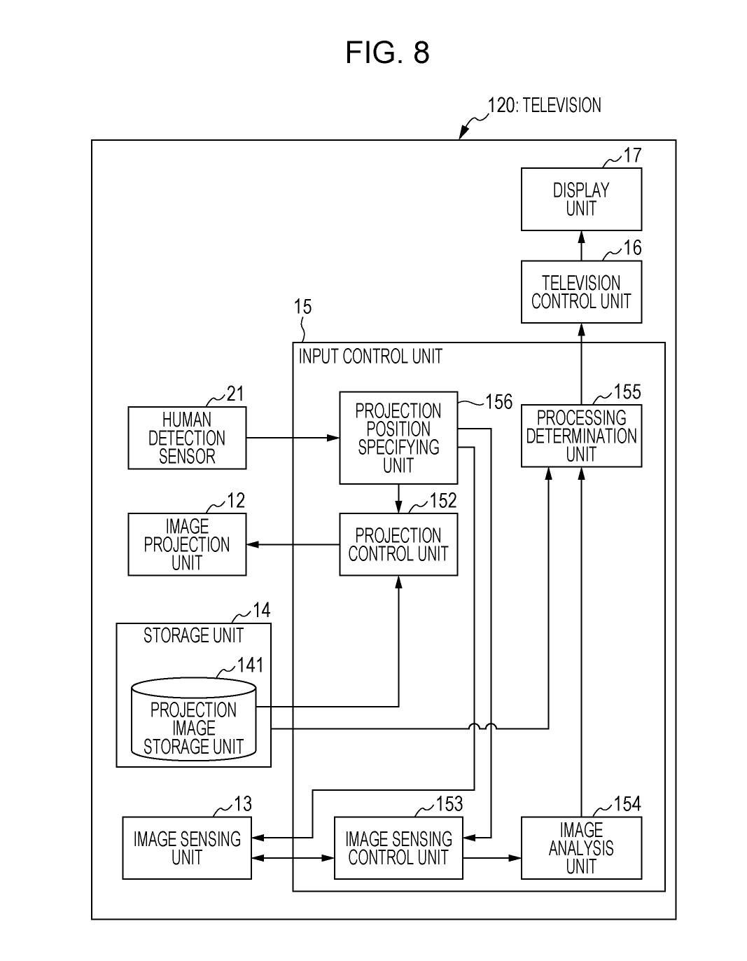

Still another embodiment of the invention will be described based on FIG. 8 as follows. Note that, for convenience of description, the same reference signs are assigned to members having the same functions as those of the members described in the aforementioned embodiments and description thereof will be omitted.

FIG. 8 is a block diagram illustrating one example of a configuration of a main part of a television 120 of the present embodiment. As illustrated in FIG. 8, the television 120 according to the present embodiment does not include the second image sensing unit 22 differently from the television 110 of Embodiment 2.

That is, when the human detection sensor 21 detects existence of the user, the projection position specifying unit 156 causes the image sensing unit 13 to execute imaging for specifying a projection position. Note that, when an imaging range of the image sensing unit 13 is narrower than the detection range of the human detection sensor 21, the image sensing unit 13 is caused to execute the imaging after controlling an image sensing direction thereof according to information of a position of the user, which is detected by the human detection sensor 21. Image data acquired by the image sensing unit 13 is supplied to the image sensing control unit 153 and a projection position of the image used for input 40 is specified. Since subsequent processing is similar to that of Embodiment 2, detailed description thereof will be omitted.

With such a configuration, it becomes unnecessary to provide two image sensing units, that is, cameras in the television 120, thus making it possible to reduce manufacturing cost of the television 1.

### Embodiment 4

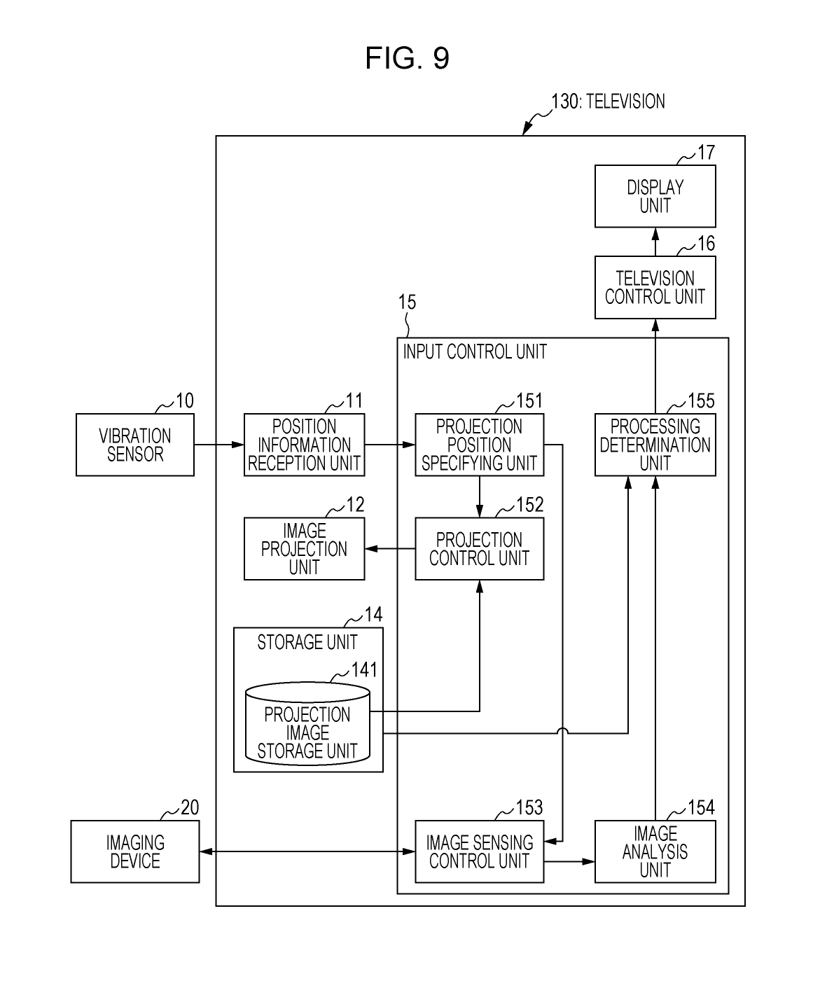

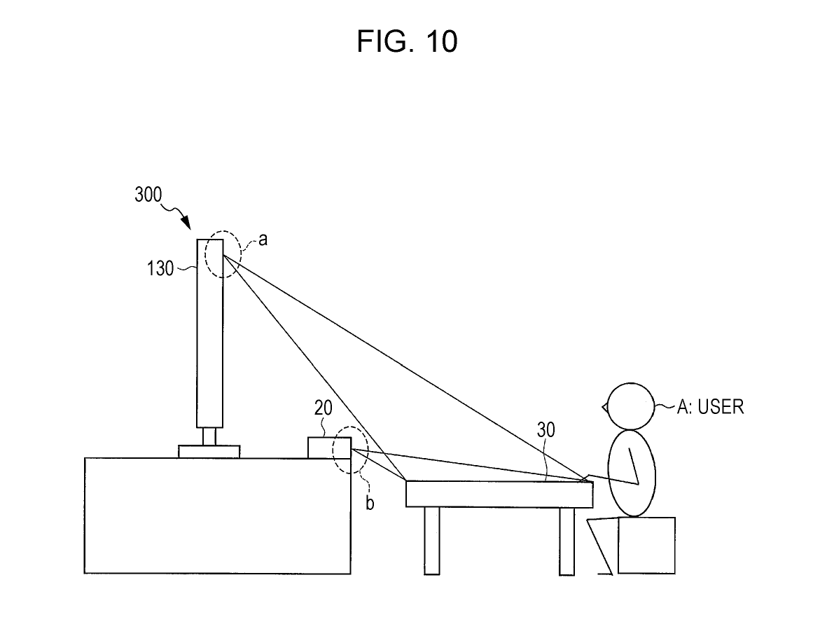

Still another embodiment of the invention will be described based on FIG. 9 and FIG. 10 as follows. Note that, for convenience of description, the same reference signs are assigned to members having the same functions as those of the members described in the aforementioned embodiments and description thereof will be omitted.

FIG. 9 is a block diagram illustrating one example of a configuration of a main part of a television 130 of the present embodiment. As illustrated in FIG. 9, the television 130 according to the present embodiment does not include the image sensing unit 13 inside thereof, and controls an imaging device 20 which is provided outside the television 130 to thereby perform imaging of an operation by the user. Therefore, the image sensing control unit 153 performs wired communication or radio communication with the imaging device 20 through a communication unit (not illustrated).

The imaging device 20 is a device including a camera for imaging an operation by the user. Note that, the number of cameras included in the imaging device 20 is not limited particularly and may be plural.

The image sensing control unit 153 transmits, to the imaging device 20, a control signal for controlling an image sensing direction of the camera included in the imaging device 20 so that an operation by the user on the image used for input 40 which is displayed at a position indicated by projection position information supplied from the projection position specifying unit 151 is able to be imaged. Further, the image sensing control unit 153 transmits an imaging execution signal for executing imaging of a region including the image used for input 40 to the imaging device 20 and receives image data indicating an image from the imaging device 20 to supply to the image analysis unit 154.

The imaging device 20 changes the image sensing direction of the camera according to the received control signal. Thereafter, when receiving the imaging execution signal, the imaging device 20 executes the imaging and transmits the image data to the television 120 (image sensing control unit 153).

Note that, in the present embodiment, the television 120 specifies a projection position of the image used for input 40 by receiving a signal from the vibration sensor 10 similarly to Embodiment 1, but without limitation thereto, may specify the projection position of the image used for input 40 by using the human detection sensor and the image sensing unit (or the second image sensing unit) like Embodiments 2 and 3.

### [Configuration of Television Control System 300]

FIG. 10 is a schematic view illustrating a configuration of a television control system 300 according to the present embodiment. The television 120 according to the present embodiment does not have a camera for imaging an operation by the user inside thereof, and as the imaging device 20, wired communication or radio communication is performed with the television 120 to acquire image data. Thus, the user is able to change an installation place of the imaging device 20 freely.

That is, as illustrated in FIG. 10, when the image used for input 40 is projected onto a top (projection surface 30) of a low table provided at a lower position than an installation position of the television 120, a dead spot due to the back of a hand or the arm of the user in a case where the camera is provided at a position of b is reduced compared to a case of being provided at a position of a, thus making it possible to take an image of an operation of the user more accurately.

Accordingly, since the imaging device 20 is able to be installed freely at a position where a dead spot is able to be reduced, it is possible to realize an input device having the high reliability in detection of an operation of the user.

### Modified Example Common in Embodiments 1 to 4

In the television 1 to the television 120 described above, a type of the image used for input 40 to be projected may be changed according to an instruction operation performed by the user on the image used for input 40 which has been projected.

Specifically, when processing corresponding to a coordinate on the image used for input 40, which is specified by the image analysis unit 154, is change of the image used for input 40, the processing determination unit 155 supplies information for specifying the image used for input 40 after the change and an instruction of the change to the projection control unit 152.

The projection control unit 152 reads the image used for input 40 from the projection image storage unit 141 according to the instruction and information which are supplied to cause the image projection unit 12 to perform projection.

Note that, for changing the image used for input 40, for example, when there is a region resembling a button for changing an image used for input in each image used for input 40 and the region is touched by the user, the projection control unit 152 may project an image for image selection with which the image used for input 40 is changed.

Thereby, without moving from a current position, the user of the television 1, 110 or 120 are able to change, for example, an image used for input resembling a remote controller and an image used for input resembling a keyboard according to intended use of the television 1, 110 or 120.

### Embodiment 5

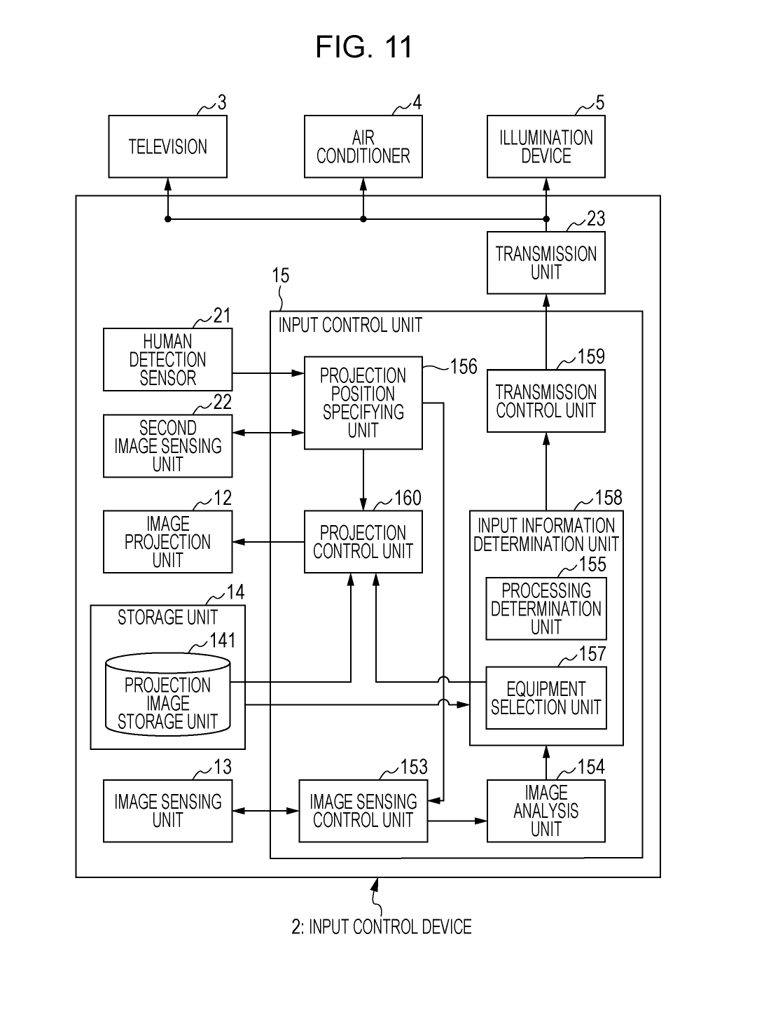

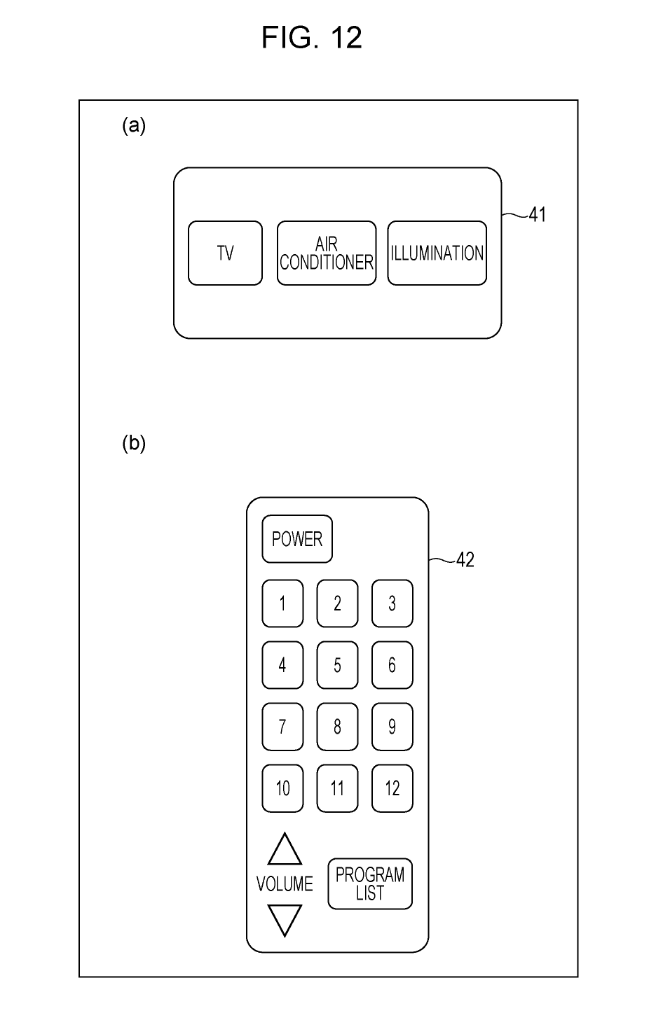

Still another embodiment of the invention will be described based on FIG. 11 and FIG. 12 as follows. Note that, for convenience of description, the same reference signs are assigned to members having the same functions as those of the members described in the aforementioned embodiments and description thereof will be omitted.

### [Configuration of Input Control Device 2]

In the present embodiment, an input control device 2 which is one aspect of the input device of the invention will be described. FIG. 11 is a block diagram illustrating one example of a configuration of a main part of the input control device 2 of the present embodiment. The input control device 2 is a device which receives an input by a user for causing a plurality of pieces of equipment (target equipment) such as a television 3, an air conditioner 4, and an illumination device 5 to execute processing. Note that, the target equipment is not limited to the above and may be any equipment capable of receiving a signal from outside to execute processing.

In the input control device 2, when there are a plurality of pieces of target equipment, with an input operation by the user on the image used for input 40, any of the plurality of pieces of target equipment is able to be selected, and processing at the selected target equipment is able to be selected.

As illustrated in FIG. 11, the input control device 2 includes an input information determination unit 158, a transmission control unit 159, a projection control unit 160 and a transmission unit 23, as a configuration which is not included in the television 1, 110 or 120 described above.

When projection position information indicating a projection position of the image used for input 40 is supplied from the projection position specifying unit 151, first, the projection control unit 160 reads an image for selecting equipment 41 illustrated in FIG. 12(a) from the projection image storage unit 141, and causes the image projection unit 12 to project the image for selecting equipment 41 at the projection position.

Further, the projection control unit 160 reads the image used for input 40 from the projection image storage unit 141 according to information of the target equipment supplied from an equipment selection unit 157 and causes the image projection unit 12 to execute projection. For example, a television remote controller image 42 illustrated in FIG. 12(b) is projected.

### (Input Information Determination Unit 158)

The input information determination unit 158 is a block which determines selected equipment and processing to be executed by the equipment, according to an input by the user to the image used for input 40. The input information determination unit 158 includes a processing determination unit 155 and the equipment selection unit 157.

Since the processing determination unit 155 is similar to the processing determination unit 155 of each embodiment described above, description thereof will be omitted.

The equipment selection unit 157 is a block which determines selected equipment according to an input by the user to the image used for input 40. Specifically, the equipment selection unit 157 refers to the storage unit 14 to thereby read information of target equipment, which is associated with a position indicated by touch position information (for example, a coordinate on the image for selecting equipment 41) supplied from the image analysis unit 154, and makes determination as the selected target equipment (which is referred to specific equipment). The equipment selection unit 157 supplies the information of the specific equipment to the projection control unit 160.

Further, the input information determination unit 158 supplies information of the specific equipment and processing to be executed by the specific equipment to the transmission control unit 159.

### (Transmission Control Unit 159)

The transmission control unit 159 is a block which controls the transmission unit 23. Specifically, by controlling the transmission unit 23, the transmission control unit 159 transmits a control signal corresponding to the processing determined by the processing determination unit 155 to the specific equipment determined by the equipment selection unit 157.

### (Transmission Unit 23)

The transmission unit 23 (transmission means) is a communication device which transmits a control signal corresponding to processing to be executed by each target equipment. Note that, transmission of the control signal from the transmission unit 23 to each target equipment is preferably transmission by radio, but may be transmission by cable.

Note that, as illustrated in FIG. 11, the projection position of the image used for input 40 is specified by using the human detection sensor 21 and the second image sensing unit 22 similarly to Embodiment 2 in the present embodiment, but without limitation thereto, the image sensing unit 13 may be used in place of the second image sensing unit 22 similarly to Embodiment 3, or a signal from the vibration sensor 10 may be received similarly to Embodiment 1 to thereby specify the projection position of the image used for input 40.

Accordingly, the user is able to project the image used for input 40, which allows an operation on a plurality of pieces of equipment, at a desired position on the projection surface 30 and operate the plurality of pieces of equipment only with the image used for input 40. Thus, the user does not need to install an input device such as a remote controller for operating each equipment. As a result thereof, there is no risk that the user loses the input device.

### [Example of Image Used for Input]

FIG. 12 is a schematic view illustrating one example of an image used for input projected by the input control device 2 of the present embodiment. FIG. 12(a) is a schematic view illustrating one example of the image for selecting equipment 41 described above. The image for selecting equipment 41 is an image for selecting target equipment serving as a target of an input, and regions resembling buttons by which the television 3, the air conditioner 4 or the illumination device 5 is able to be selected are drawn in FIG. 12(a). Note that, a region which is drawn is not limited to the example described above, and is changed according to a type of the target equipment.

When an operation of selecting target equipment is performed on the image for selecting equipment 41, an image used for input, which is used for performing an input for the selected target equipment, is projected at a specified position in place of the image for selecting equipment 41. For example, when the television 3 is selected by touch of the user in the image for selecting equipment 41, the television remote controller image 42 resembling a remote controller for a television, which is illustrated in FIG. 12(b), is projected.

In the television remote controller image 42, in the same manner as a typical remote controller for a television, regions resembling a power button for switching an operation state and a standby state of a television, a channel button for switching channels, a volume button for changing a volume and a program list button for displaying a program list are displayed. Note that, the television remote controller image 42 is one example, and a region resembling a button included in a remote controller for a television may be displayed in addition to the buttons described above.

Thereby, only by selecting target equipment in the image for selecting equipment 41, the user is able to display the image used for input 40 for executing an input to the selected target equipment. Here, for example, when the television remote controller image 42 is displayed, the user is able to view a broadcast displayed on the television 3 by performing an operation on the television remote controller image 42 like operating a typical remote controller for a television.

### [Example of Realization by Software]

A control block of the television 1 and the input control device 2 (particularly, the projection position specifying unit 151, the projection control unit 152, the image sensing control unit 153, the image analysis unit 154, the processing determination unit 155, the projection position specifying unit 156, the input information determination unit 158, the transmission control unit 159 and the projection control unit 160) may be realized by a logic circuit (hardware) formed in an integrated circuit (IC chip) or the like, or may be realized by software using a CPU (Central Processing Unit).

In the latter case, the television 1 and the input control device 2 include, for example, a CPU which executes a command of a program, which is software realizing each function, a ROM (Read Only Memory) or a storage device (which is referred to as a “recording medium”) in which the program and various data are recorded so as to be readable by a computer (or the CPU), and a RAM (Random Access Memory) which develops the program. The computer (or CPU) reads the program from the recording medium for execution, so that the object of the invention is achieved. As the recording medium, a “non-temporal tangible medium”, for example, such as a tape, a disc, a card, a semiconductor memory, and a programmable logic circuit may be used. Further, the program may be supplied to the computer via any transmission medium (communication network, broadcast waves, etc.) which is capable of transmitting the program. Note that the invention can be realized also in a form of a data signal embedded in carrier waves, into which the program is embodied by electronic transmission.

### SUMMARY

An input device (television 1, input control device 2) according to an aspect 1 of the invention is an input device that receives, from a user, an input for target equipment, including projection position determination means (projection position specifying unit 151, 156) for determining a position at which an image used for input 40, with which the user performs an input operation, is to be projected onto a projection surface 30 of an object to be projected onto, based on an operation by the user, which indicates the position, or a physical change generated in conjunction with the operation, and instructed position specifying means (image analysis unit 154) for specifying a position instructed by the user to the image used for input, which is projected onto the projection surface.

Moreover, a control method for the input device according to the aspect 1 of the invention is a control method for the input device that receives, from a user, an input for target equipment, including a projection position determination step (S3, S24) of determining a position at which an image used for input, with which the user performs an input operation, is to be projected onto a projection surface of an object to be projected onto, based on an operation by the user, which indicates the position, or a physical change generated in conjunction with the operation, and an instructed position specifying step (S7, S28) of specifying a position instructed by the user to the image used for input, which is projected onto the projection surface.

According to the aforementioned configuration, the position at which the image used for input is to be projected onto the projection surface is determined based on the operation by the user, which indicates the position, or the physical change generated in conjunction with the operation, and the position instructed by the user to the image used for input, which is projected onto the projection surface, is specified.

Thereby, by performing an operation for indicating the position at which the image used for input is to be projected, the user is able to project the image used for input at a desired position of the projection surface, and perform an input for the target equipment at the desired position.

In an input device according to an aspect 2 of the invention, the projection position determination means may analyze an image obtained by imaging the operation to thereby determine a projection position of the image used for input in the aspect 1.

According to the aforementioned configuration, by analyzing the image obtained by imaging the operation by the user, the position at which the image used for input is to be projected onto the projection surface is determined.

Thereby, since the input device according to the aspect 2 is able to determine the position at which the image used for input is to be projected without arranging a vibration sensor on the projection surface, and is therefore able to specify the projection position of the image used for input even when the image used for input is projected onto an object to be projected onto, for which the vibration sensor is not available, for example, because of generation of a large indefinite number of vibrations.

In an input device according to an aspect 3 of the invention, an image sensing unit (image sensing unit 13, second image sensing unit 22) that performs imaging of the operation, and user position detection means (human detection sensor 21) for detecting a position of the user may be further included, and the image sensing unit may be operated based on a detection result of the user by the user position detection means in the aspect 2.

According to the aforementioned configuration, the image of operation of the user is taken when the image sensing unit is operated based on the detection result of the position of the user. By analyzing the taken image, the position at which the image used for input is to be projected onto the projection surface is determined.

Thereby, the input device according to the aspect 3 is able to image the operation of the user, which indicates the projection position of the image used for input, more reliably.

An input device according to an aspect 4 of the invention may be capable of being operated also when the target equipment is in a standby state in any of the aspects 1 to 3.

According to the aforementioned configuration, the image used for input is able to be projected onto the projection surface even when the target equipment is in the standby state.

Thereby, the user is able to restore the target equipment from the standby state, in other words, operate the target equipment, with an operation of designating the position on the image used for input. Thus, the input device according to the aspect 4 is able to provide the image used for input which is usable similarly to an input device such as a remote controller.

In an input device (input control device 2) according to an aspect 5 of the invention, when there are a plurality of pieces of target equipment, with an input operation by the user on the image used for input, any of the plurality of pieces of target equipment may be able to be selected, and processing in the selected target equipment may be able to be selected, and transmission means (transmission unit 23) for transmitting, to the target equipment selected by the input operation, a signal for executing the processing selected by the input operation may be further included, in any of the aspects 1 to 4.

According to the aforementioned configuration, the signal for executing the processing selected by the input operation on the image used for input is able to be transmitted to the target equipment selected by the input operation on the image used for input among the plurality of pieces of target equipment.

Thereby, the user is able to cause the plurality of pieces of target equipment to execute the processing with the operation on the image used for input which is projected. Thus, the user does not need to install an input device such as a remote controller for each target equipment. Accordingly, the input device according to the aspect 5 is able to prevent a situation where the target device is not able to be caused to execute the processing because of missing of the input device of each target equipment.

In an input device according to an aspect 6 of the invention, the projection position determination means may determine the projection position of the image used for input by analyzing signals output from each of a plurality of vibration sensors 10, which detect a vibration generated by the operation, and the plurality of vibration sensors may be arranged on the projection surface in the aspect 1.

According to the aforementioned configuration, the position at which the image used for input is to be projected onto the projection surface is determined by analyzing the signals output from each of the plurality of vibration sensors arranged on the projection surface.

Thereby, the user is able to display the image used for input at a desired position with a minimum operation of, for example, tapping the projection surface, thus making it possible to provide an input device which is more convenient.

The input device according to each aspect of the invention may be realized by a computer, and in such a case, a control program of the input device, which realizes the input device in the computer by causing the computer to operate as each means included in the input device, and a computer readable recording medium having it recorded therein are also incorporated in a range of the invention.

The invention is not limited to each of the embodiments described above, can be modified variously within the scope defined by the claims, and embodiments obtained by appropriately combining technical means disclosed in different embodiments are also included in the technical scope of the invention. Further, by combining the technical means disclosed in each of the embodiments, a new technical feature may be formed.

Note that, the embodiments of the invention are able to be expressed as follows.

That is, a control system of the invention is a control system that performs control for operating a device, having a system control unit for controlling each unit of the device and controlling the own system, input video projection means for freely projecting, in a predetermined region, an input video for performing input to operate the device, input video projection place instruction means for instructing projection of the input video and a projection place, and operation situation input means for computerizing a situation where a user performs an operation on the input video and inputting the information to the control unit.

According to the aforementioned control system, the input video for performing an input to operate the device is able to be projected freely in the predetermined region. Further, it is possible to computerize the situation where the user performs the operation on the input video which is projected and input to the control unit. Accordingly, the user is able to project the input video at a desired position of the projection surface and perform an input for target equipment at the desired position.

Moreover, the device of the invention is preferably a device in which control is performed for the own by the control system, and which has means for operating the control system even in a standby state.

According to the aforementioned device, it is possible to operate the control system even when the device is in the standby state. Accordingly, it is possible to provide an input video with which the device is able to be operated from the standby state similarly to an input device such as a remote controller.

Moreover, a control system of the invention is a control system that performs control for operating one or a plurality of devices, having a control information sending system control unit that sends a control signal to each control unit for controlling each unit of each of the devices and controls the own system, input video projection means for freely projecting, in a predetermined region, an input video for performing an input to operate each of the devices for each of the devices, input video projection place instruction means for instructing projection of the input video and a projection place, and operation situation input means for computerizing a situation where a user performs an operation on the input video and inputting the information to the control unit.

Moreover, the device of the invention preferably has means for receiving a signal from the control system.

According to the aforementioned control system, it is possible to freely project, in the predetermined region, the input video for performing an input to operate each of the devices for each of the devices. Further, by sending the control signal to each control unit for controlling each unit of each of the devices based on the situation where the user performs the operation, it is possible to control each of the devices. Thus, the user does not need to install an input device such as a remote controller for each target equipment. Accordingly, the control system is able to prevent a situation where the target device is not able to be caused to execute the processing because of missing of the input device of each target equipment.

Moreover, in the control system, the input video projection means preferably has means for switching a plurality of input videos.

With the aforementioned control system, it is possible to switch the plurality of input videos, so that the user is able to project an input video having a desired format at a desired position.

### INDUSTRIAL APPLICABILITY

The invention is suitably usable for equipment which operates by receiving an input from a remote position, for example, such as a television, an air conditioner or an illumination device.

### REFERENCE SIGNS LIST

1 television (input device)
2 input control device (input device)
10 vibration sensor
13 image sensing unit
21 human detection sensor (user position detection means)
22 second image sensing unit (image sensing unit)
23 transmission unit (transmission means)
30 projection surface
40 image used for input
151, 156 projection position specifying unit (projection position determination means)
154 image analysis unit (instructed position specifying means)

1. An input device that receives, from a user, an input for target equipment, the input device comprising:
projection position determination unit for determining a position at which an image used for input, with which the user performs an input operation, is to be projected onto a projection surface of an object to be projected onto, based on an operation by the user, which indicates the position, or a physical change generated in conjunction with the operation, and
instructed position specifying unit for specifying a position instructed by the user to the image used for input, which is projected onto the projection surface.

2. The input device according to claim 1, wherein the projection position determination unit analyzes an image obtained by imaging the operation to thereby determine a projection position of the image used for input.

3. The input device according to claim 2, further comprising:
an image sensing unit that performs imaging of the operation, and
user position detection unit for detecting a position of the user, wherein
the image sensing unit is operated based on a detection result of the user by the user position detection unit.

4. The input device according to claim 1 capable of being operated also when the target equipment is in a standby state.

5. The input device according to claim 1, wherein
when there are a plurality of pieces of target equipment, with an input operation by the user on the image used for input, any of the plurality of pieces of target equipment is able to be selected, and processing in the selected target equipment is able to be selected, and
transmission unit for transmitting, to the target equipment selected by the input operation, a signal for executing the processing selected by the input operation is further included.
